(19) United States
(12) Patent Application Publication
(10) Pub. No.: US 2026/0238398 A1
(43) Pub. Date: Aug. 13, 2026

(54) METHODS AND APPRATUS FOR HANDLING DEPENDENCIES FOR XR TRAFFIC IN WIRELESS SYSTEMS BASED ON DISCARD MECHANISM ENHANCEMENTS WHEN PDUS ARRIVE SEQUENTIALLY

(71) Applicant: InterDigital Patent Holdings, Inc., Wilmington, DE (US)

(72) Inventors: Tejaswinee Lutchoomun, Montreal (CA); Jaya Rao, Montreal (CA); Michael Starsinic, Newtown, PA (US)

(73) Assignee: InterDigital Patent Holdings, Inc., Wilmington, DE (US)

(21) Appl. No.: 19/151,525

(22) PCT Filed: Feb. 12, 2024
(86) PCT No.: PCT/US2024/015441

§ 371 Date: Jul. 28, 2025

Related U.S. Application Data
(60) Provisional application No. 63/445,497, filed on Feb. 14, 2023.

(51) Int. Cl. H04L 1/1867; H04L 67/131

(52) U.S. Cl. CPC H04L 1/1887; H04L 1/188; H04L 67/131

(57) ABSTRACT

A wireless transmit/receive unit (WTRU) may receive a first batch of protocol data units (PDUs) of a PDU set and transmit the first batch of PDUs of the PDU set to a network entity. The WTRU may further receive a resend indication from the network entity for the first batch of PDUs of the PDU set. Based on a a time for retransmitting the first batch of PDUs and receipt of a second batch of PDUs of the PDU set, the WTRU may determine whether to retransmit the at least the portion of the first batch of PDUs and/or transmit the second batch of PDUs of the PDU set.

### CROSS-REFERENCE TO RELATED APPLICATIONS

This application claims the benefit of U.S. Provisional Patent Application No. 63/445,497 filed on Feb. 14, 2023, the entire contents of which are incorporated herein by reference.

### BACKGROUND

The term extended Reality (XR) is an umbrella term for different types of immersive experiences including Virtual Reality (VR), Augmented Reality (AR) and Mixed Reality (MR) and the realities interpolated among them. Virtual Reality (VR) is a rendered version of a delivered visual and audio scene. The rendering is designed to mimic the visual (e.g. stereoscopic 3D) and audio sensory stimuli of the real world as naturally as possible to an observer or user as they move within the limits defined by the application. Augmented Reality (AR) is when a user is provided with additional information or artificially generated objects/items or content overlaid upon their current environment. Mixed Reality (MR) is an advanced form of AR where some virtual elements are inserted into the physical scene with the intent to provide the illusion that these elements are part of the real scene. XR may include to all real-and-virtual combined environments and human-machine interactions generated by computer technology and wearables.

The notion of immersion in the context of XR applications/services refers to the sense of being surrounded by the virtual environment as well as providing the feeling of being physically and spatially located in the virtual environment. The levels of virtuality may range from partial sensory inputs to fully immersive multi-sensory inputs leading to a virtual reality practically indiscernible from actual reality.

In this disclosure, a wireless transmit/receive unit (WTRU) may correspond to any XR device/node which may come in variety of form factors. The typical WTRU (e.g. XR WTRU) may include, but not limited to the following: Head mounted displays (HMD), optical see-through glasses and camera see-through HMDs for AR and MR, mobile devices with positional tracking and camera, wearables, haptic gloves, haptic body suit, haptic shoes, etc. In addition to the above, several different types of XR WTRU may be envisioned based on XR device functions for e.g. as display, camera, sensors, sensor processing, wireless connectivity, XR/Media processing and power supply, to be provided by one or more devices, wearables, actuators, controllers and/or accessories. One or more device/nodes/WTRUs may be grouped into a collaborative XR group for supporting any of XR applications/experience/services.

In XR services and applications, the traffic may consist of data or a protocol data unit (PDU) which may be associated with an application data Unit (ADU), PDU Set or data burst. In an example, the one or more PDUs belonging to a PDU Set may be associated with different segments or components of a video frame or a video slice. A data burst may consist of one or more PDU Sets. For example, a number of PDUs in an PDU Set or data burst of a total payload size (e.g. units of bits/bytes) transmitted in the uplink (UL) and/or received in the downlink (DL) may be dependent on the type of the media frame (e.g. 3D video frame, audio frame).

### SUMMARY

In embodiments, a wireless transmit/receive unit (WTRU) may include a processor configured to receive, from an extended reality (XR) application, a first batch of protocol data units (PDUs) of a PDU set. The WTRU may transmit the first batch of PDUs of the PDU set to a network entity. The WTRU may further receive a resend indication from the network entity for the first batch of PDUs of the PDU set. In response to a determination that time for retransmitting the first batch of PDUs has not expired and a second batch of PDUs of the PDU set have been received, the WTRU may retransmit the at least the portion of the first batch of PDUs and transmit the second batch of PDUs of the PDU set. In response to a determination that the time for retransmitting the first batch of PDUs has not expired and the second batch of PDUs of the PDU set have not been received, the WTRU may indicate to the network entity that the first batch of PDUs will not be retransmitted.

In response to the determination that the time for retransmitting the first batch of PDUs has not expired and the second batch of PDUs of the PDU set have not been received, the WTRU may indicate to the network entity a reason that the first batch of PDUs will not be retransmitted.

Whether the time for retransmitting the first batch of PDUs has not expired may be based on a Packet Delay Budget (PDB) of each of the PDUs, or based on a PDU-set Delay Budget (PSDB) of the PDU set.

In response to a determination that whether the time for retransmitting the first batch of PDUs has not expired may be based on a Packet Delay Budget (PDB) of each of the PDUs, discard each PDUs at an expiry of its respective discard timer.

In response to a determination that whether the time for retransmitting the first batch of PDUs has not expired is based on a PDU-set Delay Budget (PSDB) of the PDU set, the WTRU may discard PDUs of the PDU set that were not successfully transmitted when the time for retransmitting the first bath of PDUs has expired.

In response to a determination that the time for retransmitting the at least the portion of the first batch of PDUs has not expired is associated with both each of Packet Data Convergence Protocol (PDCP) entities and the PDU set, the WTRU may prioritize a smaller of a Packet Delay Budget (PDB) or a PDU-set Delay Budget (PSDB).

A discard behavior of the PDU set may be a function of a status report to indicate successful or unsuccessful delivery of the PDU set, or a status report to indicate successful or unsuccessful delivery of the dependent PDU set.

A discard behavior of the PDU set may be based on dependencies, data types, a number of PDUs of the PDU set received, or a number of the second batch of PDUs of the PDU set received.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of the scheduling inefficiencies resulting from dependencies not being met for various PDU Sets.

FIG. 3 shows an example of the flow of two PDU Sets, with the PDU Set delay budgets (PSDB) mapped to a corresponding quality of service (QoS) flow and then to a data radio bearer (DRB).

FIG. 4 shows an example of discard mechanism enhancements in the situation when PDUs in PDU Set arrive at the same time.

FIG. 5 shows an example of discard mechanism enhancements where PDUs/PDU Sets are successfully delivered.

FIG. 6 shows an example of discard mechanism enhancements where PDUs in PDU Set arrive sequentially.

### DETAILED DESCRIPTION

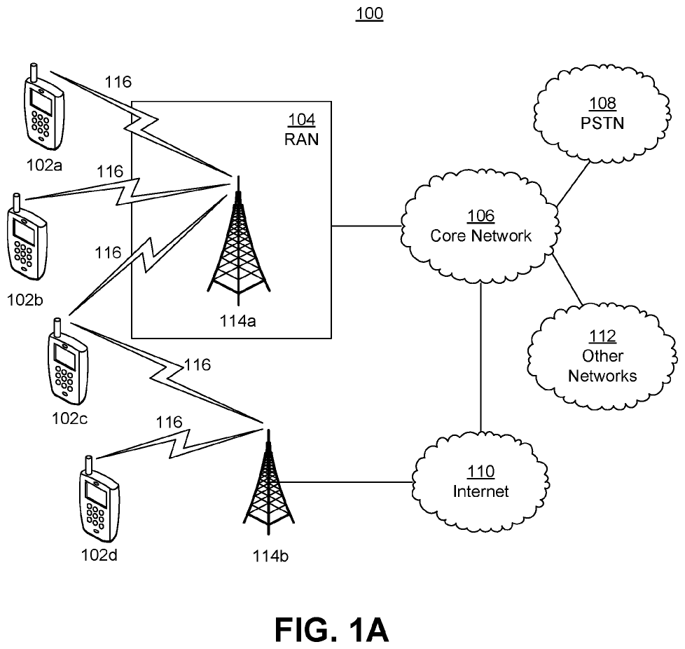

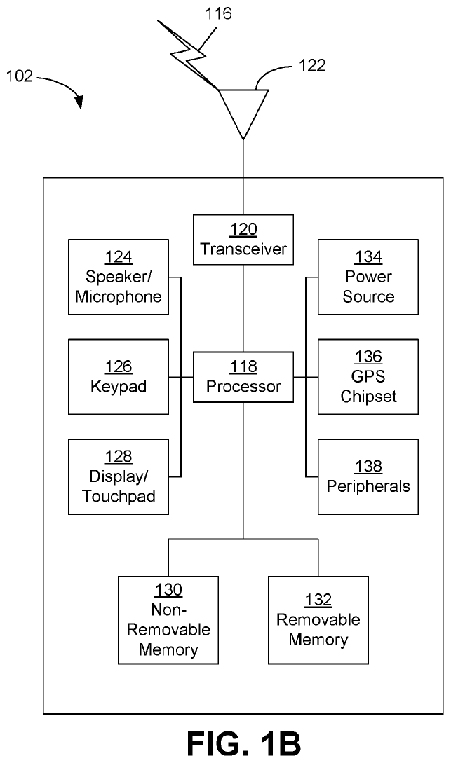

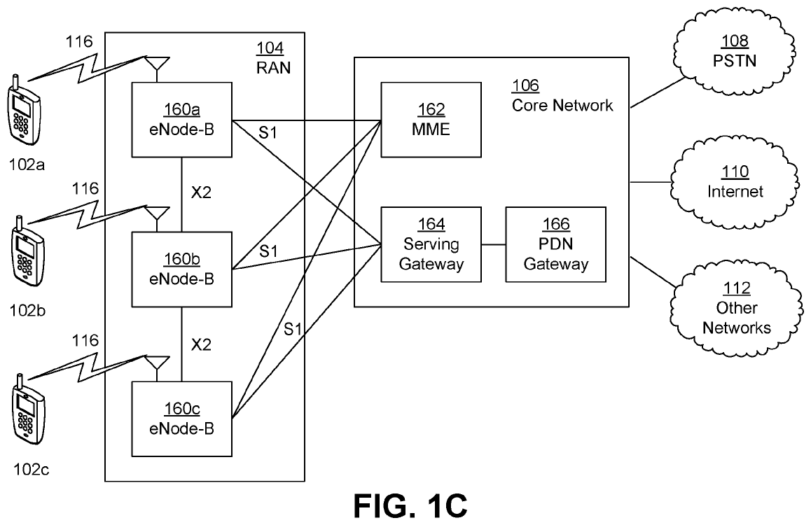

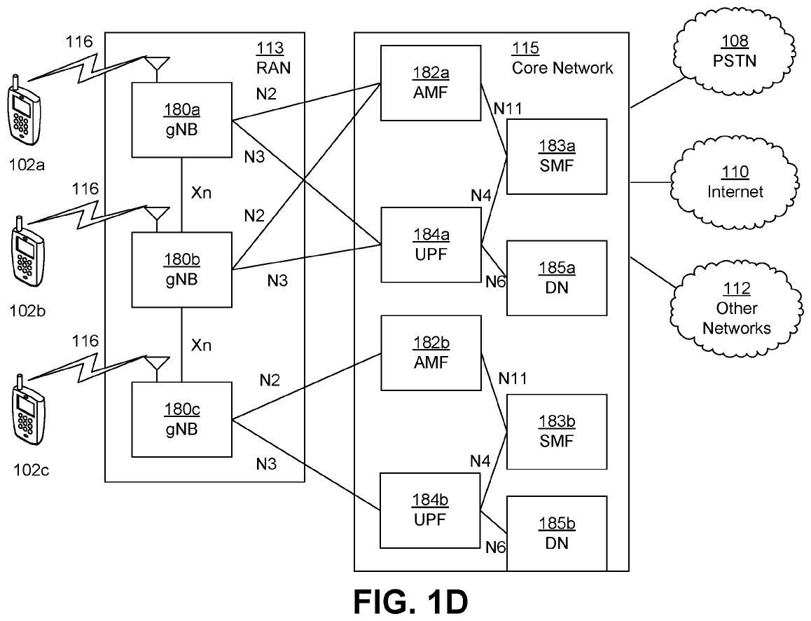

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of the WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (e.g., WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNodeB (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

One or more of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of one or more of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of one or more of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the medium access control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: the WTRU 102a-d, the Base Station 114a-b, the eNode-B 160a-c, the MME 162, the SGW 164, the PGW 166, gNB 180a-c, the AMF 182a-ab, the UPF 184a-b, the SMF 183a-b, the DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or the WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In XR traffic, dependencies may exist between PDUs (within PDU Sets or data bursts), between PDU Sets, between data bursts, and/or across multiple flows. A dependency between PDUs may be defined by data type, transmission/arrival time, and/or other dependency parameters. For example, the PDUs may include multimedia data, such as video data and/or audio data. The multimedia data may include different data types that may be dependent on one another. In one example, when the PDUs or PDU sets include intra-coded picture frames (I-frames), predicted picture frames (P-frames), and/or bidirectional predicted picture frames (B-frames), the P-frames and/or B-frames may be dependent on one or more I-frames. The I-frames may include an entire image and may be encoded without reference to other frames. The P-frames and/or B-frames may include image and/or video data and may reference other frames, such as I-frames or other P-frames/B-frames. As such, the P-frames and/or B-frames may be dependent on other frame types. There may also be dependencies between any two frames or type thereof.

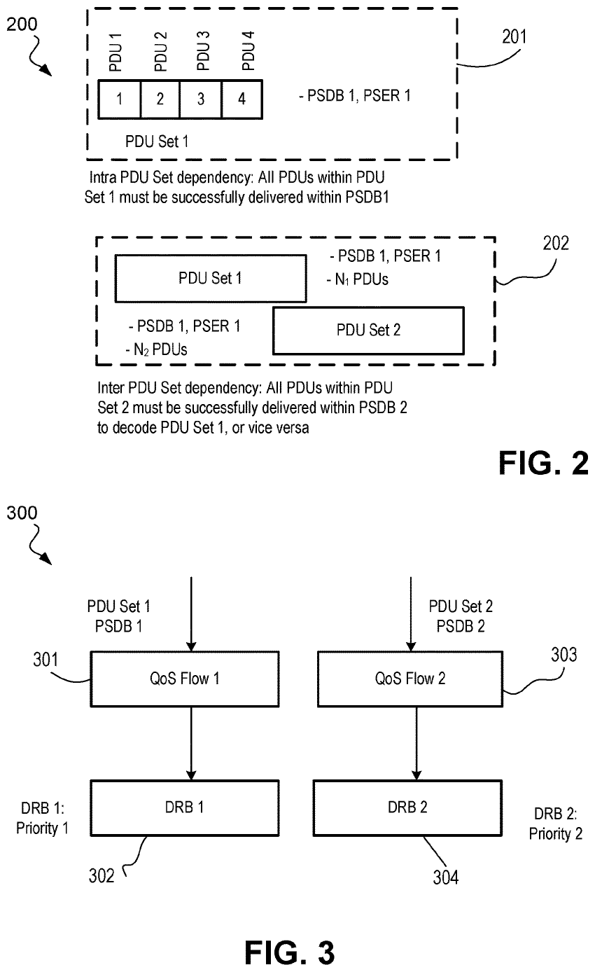

FIG. 2 in the process 200, shows an example of the scheduling inefficiencies resulting from dependencies not being met for various PDU Sets. As used herein, at 201, dependencies between PDUs (e.g., PDUs 1-4) of a PDU Set may be referred to as Intra-PDU Set dependencies. For Intra PDU Set dependency, each PDU within PDU Set 1 may be successfully delivered within a PDU Set delay budgets (PSDB), such as PSDB 1. PDU Set Delay Budget (PSDB), as defined in Release 18 XR (TR 23.700-60) may be the time between reception of the first PDU (at the UPF in DL, at the UE in UL) and the successful delivery of the last arrived PDU of a PDU Set (at the UE in DL, at the UPF in UL). Further, at 202, dependencies between one or more PDU Sets may be referred to as Inter-PDU Set dependencies. For Inter PDU Set Dependency, each PDU within PDU Set 2 may be successfully delivered within PSDB 2 to decode PDU Set 1, or vice versa.

PDU-sets may be implemented for the handling and delivery of a group of PDUs belonging to one PDU-set as being composed of one or more PDUs carrying the payload of one unit of information generated at the application level (e.g., a frame or video slice for XRM Services). In some implementations PDUs in a PDU Set may be needed by the application layer to use the corresponding unit of information. In other implementations, the application layer may still recover parts of the information unit, when some PDUs are missing.

There may be multiple types of PDU Sets for different types of applications and/or data types e.g., video data, audio data, etc.). A first type of PDU Set (e.g., Type I) may not tolerate any loss/delay for any PDU of the PDU Set or a loss/delay above a predefined threshold. When a loss or delay is above a threshold (e.g., loss or delay one of the PDUs above a period of time), the rest of the PDUs may be dropped. A second type of PDU Set (e.g., Type II) may tolerate some loss/delay or a loss/delay above the predefined threshold. XR application may reconstruct the PDU Set with delay/loss of some PDUs of PDU Set, depending on the types of applications and/or data types.

PDU Set integrated indication (PSII) or PDU Set Integrated Handling Indication (PSIHI) may be implemented for handling PDUs in different types of PDU sets depending on certain parameters. A PDU set mapped to a QOS flow with the PSII or PSIHI indicator may be a type of type where each of the PDUs of the PDU set are implemented for the successful decoding of the PDU set at the application. PDU sets may have a PSII or PSIHI indicator. Or other constructs to which PDU sets are mapped (e.g., QoS flow, DRB, LCH, etc.) may have a PSII or PSIHI indicator. The absence of such an indicator may indicate a non-PSII or non-PSIHI PDU set, e.g., a PDU set which may be decoded at the application even if one or more PDUs of the PDU set are lost and/or delayed beyond the PSDB. For example, the PDU Set QOS parameters may be defined to support PDU Set handling for different types of PDU Sets. A device, and/or application executing thereon, may use the PDU Set QoS parameters to determine whether or not each of the PDUs in a PDU Set are needed for the usage of PDU Set by the application layer (PDU Set Integrated Indication) (e.g., to meet a certain quality threshold of service).

Dependencies not being met (e.g., by successful reception and/or decoding of dependent PDUs/PDU Sets within certain timeframes) may result in scheduling inefficiencies. For example, unsuccessful transmission/reception of one PDU Set may render other successfully delivered PDU Sets useless, since the application executing on a device cannot decode the dependent PDU Sets. In addition, the discard of one PDU Set at packet data convergence protocol (PDCP), e.g., due to expiry of PDCP timer, may render other dependent PDU Sets useless. The same may apply for intra PDU Set dependencies, as shown in FIG. 2.

Embodiments are described herein to handle dependencies in XR traffic. Examples are described for handling dependencies in XR traffic during discard of PDUs/PDU Sets.

In using certain discard mechanisms, a discardTimer may be implemented for determining when to discard certain data at a transmitting entity. When the discardTimer expires for a PDCP service data unit (SDU), or the successful delivery of a PDCP SDU is confirmed by PDCP status report prior to the expiration of the discardTimer, the transmitting PDCP entity may discard the PDCP SDU along with the corresponding PDCP Data PDU. If the corresponding PDCP Data PDU has already been submitted to lower layers, the discard may be indicated to lower layers.

In some procedures for DRB and LCH selection/mapping, an LCP procedure and a discard mechanism handle packets on a per-PDU basis. They may not be adapted to handling packets on a PDU Set-basis. Further, they may not be adapted to handle any dependencies that may exist between PDUs of a PDU Set or between multiple PDU Sets. In XR, dependencies being violated may result in higher PDU Set error rate (PSER) and scheduling inefficiencies.

In an example, an unsuccessful transmission/reception of one PDU Set may render other successfully delivered PDU Sets useless, since the application executing on a device cannot decode the dependent PDU Sets. Further, discard of one PDU Set at PDCP (e.g., due to expiry of PDCP discardTimer) may render other dependent PDU Sets useless. Based on these issues, procedures may be implemented to consider dependencies in XR traffic when managing dependent PDUs/PDU Sets, as described herein.

In embodiments, discard mechanisms may be applied based on a consideration of dependent PDUs/PDU Sets. For example, a WTRU may receive XR data from an XR application for being transmitted to a network entity. The WTRU may identify a data type associated with the XR data and handling information for the indicated data type. As described herein there may be different types of PDUs/PDU sets (e.g., Type I or Type II) to consider for tolerating loss/delay for any PDU of the PDU Set. The WTRU may transmit the XR data to a network entity and receive feedback (e.g., in the form of a status report). When the feedback indicates a negative acknowledgement (NACK), the WTRU may determine whether a time duration for retransmitting the XR data is still valid. In response to a determination that the time duration for retransmitting the XR data is still valid, the WTRU may retransmit the XR data. In response to a determination that the time duration for retransmitting the XR data has expired and the data type is a first data type (e.g., Type I), the WTRU may discard the XR data. In response to a determination that the time duration for retransmitting the XR data has expired and the data type is a second data type (e.g., Type II), the WTRU may discard the XR data and indicate to dependent Packet Data Convergence Protocol (PDCP) entities to drop dependent XR data associated with the XR data.

One example illustrates the application of discard mechanisms when the PDUs in a PDU Set arrive at the same time. When data units (e.g., PDU Sets, PDUs) mapped to different PDCP entities are not successfully delivered, discarding across multiple PDCP entities may be desired. In such an embodiment, the steps involved may include the WTRU receiving the XR data from XR application, e.g., PDU Set 1. The WTRU may identify data types (e.g., Type I or Type II) associated with XR data (e.g., PDU Set 1) and/or flag indicating data type handling. The WTRU may transmit XR data in the UL to gNB. Further, the WTRU may receive a status report (e.g., PDCP status report) from gNB indicating negative acknowledgement (NACK), and may retransmit the one or more PDUs of the PDU Set (e.g., PDU Set 1). If the time duration for retransmitting the data unit is still valid (e.g., PDCP timer(s) of PDU Set 1 still running), the WTRU may retransmit the PDUs of PDU Set 1. If the PDCP timer(s) (e.g., PDU timer(s) or PDU Set timer(s) for XR data unit has expired, and the data type of the PDU Set is of the second data type (e.g., Type II), the WTRU may fall back to discarding any remaining PDUs of PDU Set 1 for example. If the PDCP timer(s) (e.g., PDU timer(s) or PDU Set timer(s) for XR data unit has expired, and the data type of the PDU Set is of the first data type (e.g., Type I), the WTRU may discard XR data units (e.g., copies of PDU Set 1 or remaining PDUs of PDU Set 1); the WTRU may indicate to dependent PDCP entities to drop all dependent XR data units (e.g., PDU Set 2); the WTRU may send an indication to gNB (e.g., PDCP entity 2 in gNB) indicating to drop/discard/release any context associated with dependent PDU Set 2 (e.g., SN); and/or if the dependent PDU Set in dependent PDCP entity (e.g., PDCP 2) has already been submitted to the lower layers (e.g., the WTRU Radio Link Control (RLC) entity), the WTRU (e.g., PDCP 2) may send a discard indication to lower layers (e.g., RLC 2) to avoid SN gap.

In embodiments for the discard mechanism, when the PDUs/PDU Sets are successfully delivered the WTRU that receives XR data from XR application, e.g., PDU Set 1, may transmit XR data in the UL to the gNB. If the WTRU receives a status report indicating successful delivery of XR data at the gNB, the WTRU (transmitter side) may discard copies of the successfully delivered PDU Set following reception of a status report from the gNB (receiver side, e.g., PDCP entity at gNB). Status reports may be sent from the receiver (e.g., receiving PDCP entity in network) to the transmitter (e.g., transmitting PDCP entity in WTRU) to confirm successful delivery of a PDU. Such status report may be on a per-PDU basis. There may be one status report transmitted from the receiver to the transmitter to indicate the delivery status of the PDU set (e.g., one status report per PDU set). The delivery status may include successful or unsuccessful delivery or delayed delivery of the PDU set.

In embodiments, discard mechanism enhancements may be applied when PDUs in PDU Set arrive sequentially. For example, the process may include the WTRU receiving a first batch of PDUs of a PDU Set from XR application at time t₁, t₁<t_{A′}. The WTRU may transmit a first batch of PDUs of PDU Set in the UL. The WTRU may receive a resend indication for first batch of PDUs from gNB (e.g., receiving PDCP entity at gNB). If the WTRU has received the remaining PDUs of PDU Set by t_{A′} and the PDCP timer(s) for first batch of PDUs of PDU Set is still running, the WTRU may transmit the remaining PDUs of PDU Set in the UL; and/or the WTRU may retransmit the first batch of PDUs following resend indication from gNB. If the WTRU has not received remaining PDUs of PDU Set by t_{A′}, the WTRU may determine not to resend first batch of PDUs of the PDU Set, even if PDCP timer(s) for first batch still running; and/or the WTRU may send an indication to gNB (e.g., receiving PDCP entity at gNB) that the first batch of PDUs of the PDU Set will not be retransmitted (to avoid any gap in sequence numbering). Further, the WTRU may include an indication as to why retransmission is not being followed through despite resend indication from gNB (failure to receive remaining PDUs of PDU Set on time).

Within the discussion herein, the term network (NW) may include one or more of a base station (e.g., gNB, transmission/reception point (TRP), RAN node, access node), core network function (e.g. AMF, SMF, policy control function (PCF), Network Exposure Function (NEF)) and application function (e.g. edge server function, remote server function), for example. Further, flows may correspond to one or both of QoS flows or data flows. For example. The flow of data consisting of one or more PDUs, PDU Sets or data bursts, may be associated with one or more QoS requirements, e.g., latency, data rate, reliability, Round Trip Time (RTT) latency). Different flows, possibly originating from a common application/experience source and/or intended to a common destination device/WTRU or group of associated devices/WTRUs may be referred to associated flows or correlated flows.

Within the disclosure herein, data unit may refer to one or more frames (e.g. media/video/audio frame or slice/segment), PDUs, PDU Sets, data bursts, and group of frames/PDUs/PDU-sets/data bursts. The term may also be applied to

The term quality of experience or QoE may correspond to one or both of an application and/or higher layer metrics and measurements, which may be directly or indirectly detectable/visible at the WTRU and/or application function. Such QoE metrics and measurements may or may not be directly visible/detectable at the base station, for example. Such QoE metrics and measurements may be determined/performed as a function of QoS metrics/parameters (e.g., latency, data rate, reliability, RTT/Motion to Photon (MTP) latency).

Within the discussion herein, forwarding configuration may correspond to one or more of radio bearers (e.g. data radio bearers (DRBs) and/or signaling radio bearers (SRBs), logical channels (LCHs), logical channel groups (LCGs), configuration parameters in the individual layers within the AS protocol stack (e.g. service data adaption protocol (SDAP), PDCP, RLC, MAC, physical layer (PHY), other protocol layers), parameters associated with logical channel prioritization (LCP) (e.g. priority, PBR, BSD), bandwidth parts (BWPs), carriers, radio links/interfaces (Uu links, Sidelinks (SLs)), and radio resources (e.g. set of one or more frequency/time/spatial resources such as symbols, slots, subcarriers, resource elements or beams). Radio resources may be associated with configurated grants or cell group (CG), dynamic grants (DG) and/or any other resource grants or grant free resources.

Mapping configuration may be used to correspond to one or more of the parameters and/or configurations associated with mapping. For example, a mapping configuration may be data units, PDUs, SDUs, PDU Sets, data bursts, application data (e.g. ADU) flows, and QoS flows (e.g. associated or non-associated). These parameters and/or configurations may originate from any of application layer, higher layers, and network to one or more radio bearers (e.g. DRBs, SRBs), layers, sublayers or entities (e.g. SDAP, new layer, PDCP, RLC, MAC, PHY), LCHs, carriers or component carriers (e.g. CCs in CA configurations), BWPs, and radio links/interfaces (e.g. Uu link or sidelinks). Further, these parameters and/or configurations may be used for delivering the data/PDUs in UL direction or DL direction, for example.

As used herein the terms XR/application-aware data transmissions/receptions or XR/application-aware QoS handling may correspond to one or more of the attributes associated with PDU Set, ADU or data burst: A PDU Set (e.g., media unit, video frame) may comprise of one or more PDUs. A PDU Set may be associated with PDU Set-level QoS requirements (e.g. data rate, latency, error rate, reliability), which may be applicable for one or more or all PDUs associated with the PDU Set. The different PDUs in a PDU Set may be associated with individual PDU-level QoS requirements. A data burst may refer to the data produced by the application in a short period of time, comprising PDUs from one or more PDU Sets. Such attributes, associations and inter-dependencies (e.g. intra-PDU Set and/or inter-PDU Set), including the start/end indication of a PDU Set/data burst (e.g. via sequence number, start/end indication), start/end time, duration, payload sizes, periodicity, importance/priority and QoS (e.g. PSDB) may be visible to the AS-layers (e.g. with associated IDs) and/or handled at the AS layers with the awareness of the association during data transmission in UL and reception in DL.

XR/application-aware data transmissions/receptions or XR/application-aware QoS handling may also correspond to the application or high layer importance or priority: The different PDUs in a PDU Set or all PDUs in a PDU Set may be associated with different application/high layer importance/priority values. Such importance value may correspond to spatial importance (e.g. spatial position of the video frame whose data is carried by the PDU/PDU Set, where PDUs/PDU Set carrying Field of View (FoV) spatial positions may be associated with higher spatial importance than non-FoV spatial positions) or temporal importance (e.g. time sequence of the video frame who data is carried by the PDU/PDU Set, where PDUs/PDU Sets carrying base video frames such as I-frame may be associated with higher temporal importance than differential video frames such as P-frame/B-frame). Such importance values may be visible to the Access Stratum (AS) layers (e.g., with associated IDs/markers/indications), possibly enabled by application awareness, during data transmission and reception. These terms may also correspond to QoS/data flow. The PDUs/PDU Sets of an application may be encoded and delivered by the application to the WTRU (in UL) or network (in DL) via one or more QoS/data flows. In this regard, the different QoS flows carrying the PDUs/PDU Sets associated to an XR application/experience may be visible to the AS-layers (e.g. with associated IDs) and/or handled at the AS layers with the awareness of the association during data transmission and reception.

WTRU actions, such as related to application actions and/or AS-layer actions for ensuring/supporting differentiated QoS, may correspond to one or more of determining of metadata of application, or an XR application. In example, the determination of metadata may involve determining any of the FoV/visual/spatial perimeters, 2D/3D size, border, spatial attributes and boundaries of FoV, based on measurements in any spatial dimensions, including but not limited to longitude, latitude, altitude, depth, roll, pitch, yaw in one more coordinate systems (e.g. cartesian, spherical). In a further example, the determination of metadata may involve determining the quality of the FoV content, e.g., whether the FoV content is of high quality, which in the case of an image, may be quantified and assessed by the image resolution (e.g. number of density of megapixels). As a further example, the determination of metadata may involve determining the importance and/or priority of the FoV content. The importance may be associated with the spatial importance and/or temporal importance of content/data, for example. For example, the spatial/temporal importance value may indicate the absolute or relative importance associated with the FoV content. Spatial importance may be associated with one or more segments/tiles/slices/positions of FoV in spatial dimension, for example. Temporal importance may be associated with one or more frames/subframes of FoV in time dimension, for example.

WTRU actions may also correspond to the determining/generation of application content. In examples, the determination of application content may involve determining/capturing the one or more 2D/3D images/video frames associated with an FoV boundary/perimeter/border as defined by the FoV metadata by the WTRU/node for itself and/or on behalf of another WTRU/node. For FoV content mapping, the WTRU may determine the images/video frames using visual sensors (e.g., 2D/3D camera, lidar), RF sensors (e.g., RF transceiver, RADAR), audio sensors (e.g., sonar), etc. Herein, the mapping of FoV may also be referred to as sensing of FoV content or capturing of FoV content. In another example, the determination of application content may also include recording/capturing of audio frames, either as part of the real environment or as part of an overlaid sound-track/audio file with the audio file originating from a source other than the current real environment being mapped.

WTRU actions may further correspond to performing measurements and reporting the measurement information. In an example, the WTRU may perform measurements of positioning/spatial/pose (e.g. 6DoD/3DoD orientation, location/position), rate of motion/movement, etc. of the user/WTRU and/or other objects (e.g. virtual or real) which the user may be interacting with. The WTRU may send/report the pose measurements to network, periodically or when detecting event triggers (e.g. change in pose measurements above/below a threshold). Another example may include the WTRU performing measurements of one or more of reference signals or channels (e.g. Synchronization Signal Block (SSB), channel state information (CSI) reference signal (RS), PRS, sidelink RS), GNSS signals, unlicensed carriers, ultra-wideband signals, LIDAR signals, visual signals, etc. In other examples, the WTRU may perform measurements of the radio link interfaces associated with the WTRU (e.g. Uu link, SL), the WTRU may trigger transmission and/or measurement of reference signals in other one or more WTRUs (e.g. via Uu link and/or sidelink), and/or the sending of measurement report to network and/or another WTRU.

WTRU actions may further correspond to handling/forwarding of data/PDUs/PDU Sets and the handling QoS associated with PDUs/PDU Sets. In an example, the data may include any of media/image/video frames, sensor data, and measurement data (e.g. pose measurements, link/channel measurements) determined by the WTRU, possibly for supporting an application/service/network request associated with the WTRU. In another example, the WTRU may send and/or receive data, to/from one more destinations including RAN node (e.g. gNB), CN function/entity, application function (e.g. hosted in the WTRU or in network). Still further, the WTRU may perform splitting/merging of data/PDUs in one or more QoS flows into one or more forwarding configurations during transmission/receptions.

WTRU actions may still further refer to the handling/forwarding of information related to connectivity with network and/or other WTRUs. For example, sending capability information to network may include one or more of capability for supporting one or more traffic flows with different XR traffic patterns (e.g. periodic/aperiodic, PDU Sets with variable payload sizes), capability for performing application layer measurements (e.g. QoE measurements, application buffer measurements, RTT measurements), and capability for detecting changes to traffic patterns. A further example may involve the sending of inter-WTRU coordination capability information to network, including capability for supporting one or more interfaces, capability to coordinate and/or interact with other WTRUs/devices (e.g. via SL interfaces), which may be co-located or non-co-located with the WTRU. Further examples may include one or more of receiving configuration, including receiving RRC configuration from gNB and/or NAS-layer configuration from CN; sending and/or receiving assistance data to/from network associated with traffic, QoS, scheduling, etc., for supporting UL/DL transmissions; and sending requests for radio resources and/or resource grants (e.g. dynamic grants, semi-static/configured grants).

In the various embodiments herein, there may be common components. With regard to the determination of dependencies in traffic, dependency may refer to both intra-PDU Set dependency, that is the dependency between different PDUs of a PDU Set or the inter-PDU Set dependency, that is the dependency between one or more PDU Sets. Dependency may also refer to dependency between different PDU Sets in a data burst (e.g., different PDU Sets received within a short time window). Dependency may be determined by or known/communicated to the WTRU via the importance markings added at the application or SDAP or a new layer above/below the SDAP. For example, the importance markings may be added to the data unit (e.g., in the header of each PDU Set) or sent as metadata (e.g., via separate signaling). Further, the lower layers may be able to read the importance marking and infer any dependencies from the importance marking. Dependency may be determined by or known/communicated to the WTRU via the SN markings added at the application or SDAP or a new layer above/below the SDAP. For example, the Importance markings may be added to the data unit (e.g., in the header of each PDU Set) or sent as metadata (e.g., via separate signaling). Further, the lower layers may be able to read the importance marking and infer any dependencies from the importance marking (e.g., PDUs 1,2,3 of PDU Set 1 may be marked as [1,1], [1,2], [1,3] and PDUs 1,2 of PDU Set 2 may be marked as [2,1], [2,2].)

Dependency may further be determined by or known/communicated to the WTRU via the arrival times, for example, time keeping (e.g., at SDAP/PDCP, w.r.t. time reference (e.g., SFN), time window start/end time) and/or the lower layers may assume dependencies within two data units (e.g., two PDU Sets) that arrive within a time window of each other. Dependencies may also be determined by or known/communicated to the WTRU via the data type. For example, the subsequent frames may depend on a first one or more frames (e.g., second frame depending on first frame). Further, one frame type may be dependent on another frame type, e.g., dependent/differential frame (e.g., P-/B-frame) depending on an I-frame. A further example may be where one PDU Set Type I has higher dependencies between the constituent PDUs of the PDU Set since by definition, PDU Set Type I may not tolerate any loss/delay of any PDU in the PDU Set; as compared to PDU Set Type II-which may tolerate loss/delay of one or more PDUs in the PDU Set.

Dependency may further be determined by or known/communicated to the WTRU via the QoS flow. For example, the WTRU may determine that two PDU Sets that arrive in the same QoS flow are dependent on each other. Dependency may further be determined by or known/communicated to the WTRU via the explicit indication from higher/application layer. For example, the higher/application layer may explicitly mark two data units that are dependent on each other since the application may require both data units at the other end. For example, the application may mark PDU Set 1 and PDU Set 3 as dependent on each other (e.g., via in-band marking of PDU Set 1 and PDU Set 3 or via separate signaling indicating dependencies between PDU Set 1 and PDU Set 3) so that the lower layers in the WTRU (e.g., AS layers) may treat PDU Set 1 and PDU Set 3 in a way to maintain the dependencies. Other examples may involve the higher/application layer providing an application layer packet. The packet may be considered a PDU. The application layer packet may be an RTP packet. The packet may include a header that describes the PDU. As such, there may be a field in the header that indicates the priority (e.g., importance) of the packet relative to other packets of the same stream. The WTRU may determine that packets with the same priority value in the header are dependent on one another. There may also be a field in the header that indicates a sequence number. The WTRU may determine that PDU Sets that are associated with consecutive sequence numbers are associated with one another (e.g. a PDU Set that is associated with sequence number 4 and a PDU Set that is associated with sequence number 5 are associated). Still further, there may be a field in the header that indicates dependency. For example, dependency indication may be called a correlation ID and PDU Sets that include the correlation ID in the header may be considered dependent on one another. Alternatively, the WTRU may receive PDU Set handling rules in a NAS message. The PDU Set handling rules may be received as part of a QoS Rule. The PDU Set Handling Rules may indicate correlation ID values that should be considered to be associated with one another. For example, the PDU Set Handling Rules may indicate that Correlation ID values 5 and 3 are associated. The WTRU may then determine that any packets with a Correlation ID of 3 or 5 in the header are associated with one another.

Dependency may further be determined by or known/communicated to the WTRU via a combination of any one or more of the above. For example, the WTRU may determine that two PDU Sets of the same importance or priority that are sent consecutively (or within a short specified time window of each other) are dependent on one another. As a further example, the WTRU may determine that two PDU Sets of the same type with arrival times within a short time window of each other are dependent.

Other embodiment common components may include information on the traffic characteristics. The WTRU may send information (e.g., to the NW) or receive information (e.g., from the higher/application layers or from the NW) or determine information on the traffic characteristics: This information may include PDU Set size, number of PDUs per PDU Set, number of PDUs in data burst in one or more traffic flows. The information on traffic characteristics may include instantaneous measurements/determination and/or statistical/distribution info such as mean, min, max, standard deviation values. The information related to PDU Set may include size of the PDU Set (e.g., total payload, number of PDUs in PDU Set), indication of start/first and/or end/last PDU of PDU Set, and indication of the association/dependency of the PDUs in a PDU Set (e.g. ID of PDU Set, importance/priority value). As an example, the WTRU may receive information (e.g., from the XR application) on the number of PDUs in a PDU Set and an indication of the first PDU in the PDU Set. Based on these pieces of information, the WTRU may determine the size of the PDU Set and the last PDU of the PDU Set. As a further example, the WTRU may have received PDUs 1,2,3 from a PDU Set. Based on information on the PDU Set size (e.g., in terms of the total number of PDUs in the PDU Set), the WTRU may determine that PDUs 4,5,6 of the PDU Set are still pending and should be received soon (ideally within a time window that may allow the WTRU to transmit all the PDUs in the PDU Set within the PDU Set delay budgets (PSDB). A still further example may involve the WTRU sending to the NW or receive from the NW/application/higher layers information on PDU Sets and/or data bursts in one or more data/QoS flows, including the number of PDUs or PDU Sets (e.g., instantaneous, mean, max, min), payload size of PDU Sets and/or data burst in units of bits/bytes (e.g., instantaneous, mean, max, min), periodicity, importance/priority, start and end indication of a PDU Set and/or data burst (e.g. ID of first PDU/PDU Set, ID of last PDU/PDU Set), and dependency info within PDU Set and/or data burst and across one or more PDU Sets and/or data bursts (e.g., indicating whether one or more PDU Sets are dependent on one another and/or whether PDU Sets in one or more data bursts are dependent and/or whether PDUs within a PDU Set are dependent on one another, etc.).

Other examples of information on the traffic characteristics may include the WTRU sending information related to the jitter in UL and/or in DL. Such jitter info which may be sent on a per flow, per-PDU Set or per PDU basis, may include the range, mean, maximum and minimum value, for example. Still further the WRTU may send information on the importance/priority of any of the data units (e.g., PDUS, PDU Sets, data bursts) to be transmitted/received in UL/DL. The WTRU may also receive indications (e.g., from the NW or higher/application layer) on changes in the traffic pattern characteristics and/or may send indications when detecting changes in the UL/DL traffic patterns (e.g., changes in payload size, PDU Set sizes, data burst sizes, jitter range, periodicity etc.) Still further, the WTRU may send configuration to the NW via any one or more of RRC signaling and/or NAS messages (e.g., SRB0, SRB1, SRB2, SRB3, SRB4); control PDUs associated with any of the AS layers (e.g., SDAP control PDU, PDCP control PDU); UL MAC CE (e.g., existing MAC CE, new MAC CE, regular BSR, periodic BSR, enhanced BSR, padding BSR, pre-emptive BSR, etc.); UCI (e.g., single bit SR, multi-bit SR, feedback, ACK/NACK, CSI report); the PDCCH; the PUCCH; non-AS (NAS) layer signaling (e.g., PDU session related messages); and/or application layer signaling/messages.

Further common components on the embodiments may include the WTRU receiving configuration information from the network. The WTRU may receive from gNB, e.g., in RRC, a set of DRBs configured by the gNB (e.g., DRB1, priority of DRB1, DRB2, priority of DRB2). The WTRU may, e.g., from the gNB, receive rules/restrictions for mapping of DRB to LCH and/or mapping of DRB and/or LCH to resource grants (e.g., CG). The WTRU may receive from gNB, e.g., in RRC, a set of LCHs out of which some LCHs may be configured to handle dependencies. The LCH parameters (e.g., BSD, PBR, priority) may apply for all or some of the data units (PDUs and/or PDU Set and/or data bursts) mapped to the LCH. Further examples include the WTRU possibly receiving from gNB LCP configurations and changes in LCP configurations (e.g., LCP restrictions/rules/configurations for handling of PDUs/PDU Sets/data bursts) either for a certain time duration or indefinitely or until further notice (e.g., a change in LCP configuration). The WTRU may receive from the gNB indications on whether these LCP rules may be relaxed/changed temporarily for a time duration of whether they may be always applied. The WTRU may receive, as a further example, from the gNB configurations for multiplexing PDUs/PDU Sets/Data bursts into transport blocks. Still further examples include the WTRU potentially receiving configuration information from the NW via any one or more of RRC signaling and/or messages (e.g., dedicated/unicast signaling via any of SRBs, broadcast/SIB); control PDUs associated with any of the AS layers (e.g. SDAP control PDU, PDCP control PDU); the DL MAC CE, (iv) the downlink assignment index (DCI); the PDCCH; the PUSCH; non-AS (NAS) layer signaling (e.g., a PDU Session Establishment Response or a PDU Session Modification Command); and/or application layer signaling/messages.

In the various embodiments, one or more common components may include the information shown in FIG. 3. FIG. 3, in process 300, shows an example of the flow of two PDU Sets, with the PDU Set delay budgets (PSDB) mapped to a corresponding quality of service (QoS) flow and then to a data radio bearer (DRB). As illustrated, the PDU Set 1, with PSDB 1, is mapped to QoS Flow 1 301 and then to DRB1 302. Another PDU Set, PDU Set 2, with PSDB 2, is mapped to QoS Flow 2 303 and then to DRB2 304. The illustration shows conceptually that two different types of PDU Sets (PDU Set 1 and PDU Set 2), which differ in that they have different QoS requirements (PSDB1 and PSDB2), may be mapped to different QoS Flows and different DRBs. Further illustrated, one PDU Set 1 and one PDU Set 2 may be sent together at a time t. There may be one or more PDU Sets 1 (with PSDB 1) and one or more PDU Sets 2 (with PSDB 2) that are mapped to QOS Flow 1 301 and QoS Flow 2 303 respectively and to DRB 1 302 and DRB 2 304, respectively. These mapping and related examples may apply to one or more of the referred to herein. Further, PDU Set 1 may refer to PDU Set type 1, which may include one or more PDU Sets with PSDB 1 requirements. Type 1 here is not to be limited to the Type I PDU Set, referred to above. A PDU Set type 1 may be a Type I PDU Set or a Type II PDU Set, as described herein. PDU Set 1 may refer to one or more PDU sets with similar PDU Set level QoS requirements (e.g., the same or similar PSDB1, PSER1, PSII indication, etc.). Similarly, PDU Set 2 may refer to one or more PDU sets with similar PDU Set level QoS requirements (e.g., the same or similar PSDB2, PSER2, PSII indication, etc.). PDU Set 1 may be a PDU Set Type I or a PDU Set Type II. Similarly, for PDU Set 2, PDU Set 3, etc. they may be a PDU Set Type I or a PDU Set Type II.

In the following embodiments, the term PDCP refers to the Packet Data Convergence Protocol entity/layer in the WTRU or any new entity/layer in the WTRU that performs the task of transmitting/discarding of a data unit. The assumption may be that a similar/corresponding entity/layer may exist at the gNB in the network.

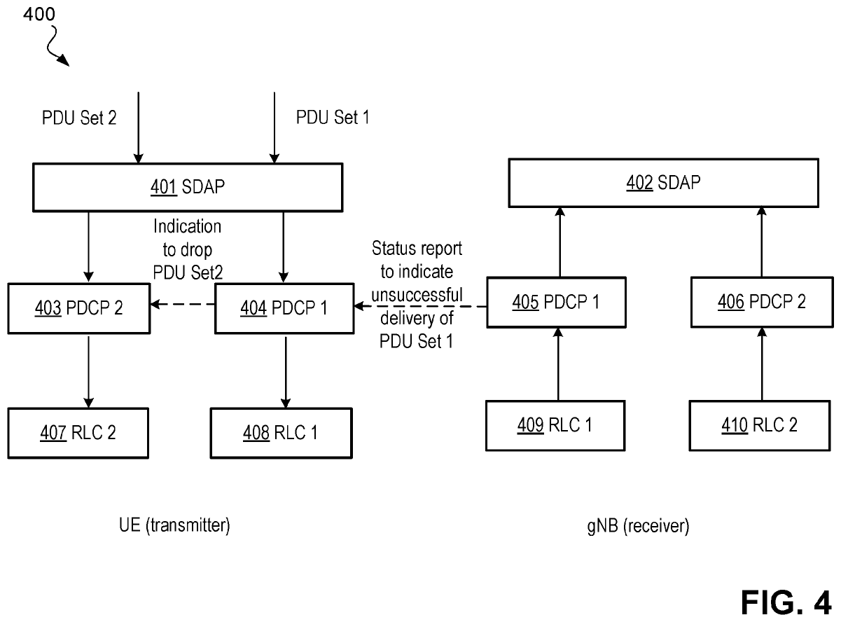

In embodiments, discard mechanism enhancements may be provided when PDUs in PDU Set arrive at the same time. FIG. 4 illustrates a process 400 that shows an example of discard mechanism enhancements to discard PDUs in the situation when PDUs in PDU Set arrive at the same time. As illustrated in FIG. 4, there may be two types of PDU sets (e.g., Type I and Type II, as described herein). Type I PDU Set may not tolerate loss/delay over a threshold for any PDU of the PDU set. When one or more of the PDUs is lost or delayed above the threshold, the rest of the PDUs may be dropped. Type II PDU Sets may tolerate some loss/delay over a threshold. XR application may reconstruct PDU Set with delay/loss of some PDUs of PDU set. The WTRU may receive XR data from XR application, e.g., PDU Set 1. The XR data may include one or more PDUs from one or more sets of PDUs. The WTRU may identify data type (e.g., Type I or Type II) associated with XR data (e.g., PDU Set 1) and/or detect or flag for PSII or identify data type and handling information for the indicated data type.

PDUs of PDU Set 1 may be transmitted to Service Data Adaptation Protocol (SDAP) 401. The PDUs of the PDU Set 1 may be transmitted via the PDCP 1 404 and the RLC 1 408. The gNB may receive one or more PDUs of the PDU Set 1. For example, the RLC 1 and/or the PDCP 1 may receive one or more PDUs of the PDU Set 1. In response to successful reception of the PDUs in the PDU set 1, the gNB may transmit a status report indicating a successful delivery of the PDU Set 1 (e.g., an ACK) to the WTRU. If one or more PDUs of the PDU Set 1 fail to be received at the RLC 1 409 and/or the PDCP 1 405, the gNB may transmit a status report indicating unsuccessful delivery of the PDU Set 1 (e.g., a NACK) to the WTRU. In response to the status report indicating unsuccessful delivery of the PDU Set 1 (e.g., a NACK), the WTRU may drop dependent PDU Set 2. For example, the PDCP 1 404 may send an indication to PDCP 2 403 to drop the PDUs of PDU Set 2 prior to transmission via RLC 2 407. The gNB may fail to receive the PDU Set 2 at RLC 2 410, PDCP 2 406, and/or SDAP 402.

The WTRU may retransmit one or more PDUs of the PDU Set (e.g., PDU Set 1). If the duration for retransmitting the data unit is still valid or if PDCP timer(s) e.g., PDU timer(s) or PDU Set timer(s) for the PDU Set (e.g., PDU Set 1) is still running, the WTRU may retransmit the PDUs of PDU Set or the XR data. If PDCP timer(s) e.g., PDU timer(s) or PDU Set timer(s) for XR data unit has expired and the data type of the PDU Set 1 is of PDU Set Type II, the WTRU may fall back to discarding any remaining PDUs of PDU Set 1). If PDCP timer(s) e.g., PDU timer(s), or time duration or PDU Set timer(s) for XR data unit has expired and the data type of the PDU Set is of PDU Set Type I, the WTRU may discard XR data units (e.g., copies of PDU Set 1 or remaining PDUs of PDU Set 1), and/or the WTRU may indicate to dependent PDCP entities to drop each of the dependent XR data units (e.g., PDU Set 2). If dependent PDU Set in dependent PDCP entity (e.g., PDCP 2 403) has already been submitted to the lower layers (e.g., the WTRU RLC entity 2 407), the WTRU (e.g., PDCP 2 403) may send a discard indication to lower layers (e.g., RLC 2 407) to avoid SN gap. If the dependent PDCP entities are within the network entity (e.g., gNB), the WTUR may signal the network entity an indication to drop the dependent XR data associated with the XR data. If the dependent PDCP entities are within the WTRU, the WTRU may signal the WTRU an indication to drop the dependent XR data associated with the XR data.

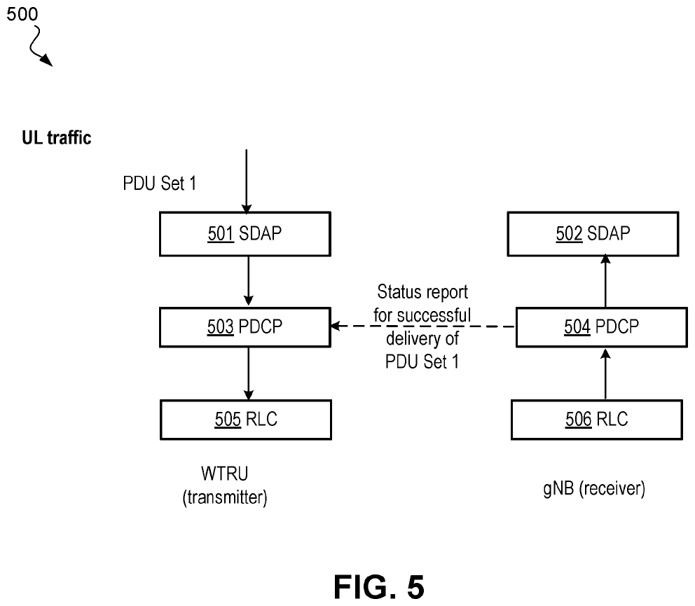

In embodiments for the discard mechanism, where the PDUs/PDU Sets successfully are delivered the process may be performed as shown in FIG. 5. FIG. 5 illustrates a process 500 that shows an example discard mechanism where PDUs/PDU Sets are successfully delivered based on the extension of status reporting on SDU basis to PDU Set basis. In the current system, status reports may be sent from the receiver (e.g., receiving PDCP entity in network) to the transmitter (e.g., transmitting PDCP entity in WTRU) to confirm successful delivery of a PDU. Such status report may be on a per-PDU basis. In one solution, there may be one status report transmitted from the receiver to the transmitter to indicate the delivery status of the PDU set (e.g., one status report per PDU set). The delivery status may include successful or unsuccessful delivery or delayed delivery of the PDU set. The WTRU may receive XR data from XR application, e.g., PDU Set 1. For example, the XR data may be received at the SDAP 501 and prepared for transmission via the PDCP 503 and the RLC 505 of the WTRU. The WTRU may transmit XR data in the UL to the gNB. The gNB may receive one or more PDUs of the XR data via the RLC 506 and/or the PDCP 504 for being provided to the SDAP 502. The gNB may prepare a status report indicating successful (e.g., ACK) or unsuccessful (e.g., NACK) delivery or receipt of one or more PDUs in the XR data. If the WTRU receives a status report indicating successful delivery of XR data at the gNB, the WTRU (transmitter side) may discard copies of the successfully delivered PDU Set following reception of a status report from the gNB (receiver side).

In embodiments, the WTRU may detect the flag for PDU Set handling or identifies data type. The concept of PDU Set may comprise handling and delivering of a group of PDUs belonging to one PDU Set. Some PDU Sets may tolerate some loss and/or delay of one or more PDUs in the PDU Set above a threshold, e.g., the XR application may still reconstruct the PDU Set with delay/loss of one or more PDUs in the PDU Set. Throughout this disclosure, such PDU Sets may be referred to as Type II PDU Sets. Other PDU Sets (referred to as Type I PDU Set herein) may not tolerate loss/delay of PDUs in the PDU Set below a threshold, e.g., the XR application may not tolerate delay/loss of any PDU in the PDU Set below the threshold. If there is delay/loss of any PDU in the PDU Set, the remaining PDUs in the PDU Set may be dropped.

In an example, it would typically be the XR application that determines whether reconstruction of PDU Sets may happen or not with some loss/delay and therefore it may be the XR application that marks the PDU Sets as Type I or Type II. The marking may be done at the NAS layers or at the AS layers (e.g., SDAP). This information may be communicated/relayed down to the lower layers so that the lower layers (e.g., PDCP) may adapt the handling (e.g., discarding) of the PDU Set accordingly. In another example, the information may be added to each PDU Set (e.g., as a marking in the header of each PDU Set) and the lower layers in the WTRU (e.g., PDCP) may be able to read it. The XR data may include a marking indicating the data type of the XR data. In a further example, the information may be added to one PDU Set and the lower layers may assume that similar information applies to all subsequent PDU Sets (e.g., all subsequent PDU Sets without marking are of the same type as the one PDU Set with the marking), until a PDU Set with a different marking reaches the lower layers.

In other examples, the type of PDU Set and the number of subsequent PDU Sets (e.g., N) of the same type may be marked in the header of a first PDU Set. The lower layers, upon receiving/reading the header of this first PDU Set may provide a similar treatment to the N subsequent PDU Sets without spending time reading the header of the subsequent N PDU Sets. Still further, the information may be sent separately as metadata to the lower layers (e.g., SDAP, PDCP, RLC, MAC, any new layer in the protocol stack) in the WTRU. Also, PDU Sets of a type may carry a flag (e.g., one-bit flag) to identify the type. For example, only Type I PDU Sets may carry a flag that indicates that the XR application cannot tolerate any loss/delay of any PDU in the PDU Set.

In a further example, the first Type |PDU Set may carry a flag to indicate its type. The lower layers may assume that the subsequent PDU Sets are also Type I. Still further, PDU Sets of a certain importance may be assumed to be of a certain type by the WTRU. For example, the WTRU may assume that any PDU Set with an importance value greater than a certain pre-set value (e.g., >8 on an importance or priority scale of 1-10 with 10 being most important) is a Type I PDU Set and therefore cannot tolerate a loss/delay of PDUs above a threshold (e.g., threshold of 1) in the PDU Set. The importance of the PDU Set may be determined by the XR application and communicated to the WTRU either in-band (e.g., in the header of a PDU Set) or in separate signalling (e.g., metadata signalling).

In another example, the application may define a parameter for the usage of the PDU Set at the application. The parameter may be, for example, a PDU Set QoS parameter that may indicate the preferred treatment of the PDU Set at the lower layer, e.g., PSII (PDU Set Integrated Indication) that indicates whether all PDUs are needed for the usage of the PDU Set at the application. The parameter may be binary (e.g., PDUs needed without any loss/delay or not) or more granular (e.g., a certain number/percentage of PDUs of a PDU Set is needed for the reconstruction of the PDU Set at the application). The parameter may be signalled to the lower layers via marking of PDU Sets (e.g., in-band marking in a header) or via separate signalling (e.g., signalling dedicated for metadata on PDU Sets).

In embodiments, one PDCP discard timer or multiple PDCP discard timers may be provided. In the PDCP framework, there may be one discard timer associated with each PDCP service data unit (SDU). When the discardTimer expires for a PDCP SDU, or the successful delivery of a PDCP SDU is confirmed by PDCP status report, the transmitting PDCP entity discards the PDCP SDU along with the corresponding PDCP Data PDU. With XR traffic consisting of one or more PDUs in a PDU Set and one or more PDU Set in a data burst with dependencies between constituent PDUs in a PDU Set or constituent PDU Sets in a data burst, the following one or more aspects may be considered when configuring the PDCP discard timer. In one example, there may be one PDCP discardTimer that is operated per PDCP SDU, where the expiry of the timer or the time duration for retransmitting the XR data takes into account or is based on the Packet Delay Budget (PDB) of the individual PDU. This configuration implies multiple PDCP discardTimers per PDU Set. In another example, there may be one PDCP discardTimer or the time duration for retransmitting the XR data that is operated per PDCP SDU and in this configuration, the expiry of each constituent timer of each PDU Set takes into account or is based on the PSDB of the PDU Set (and not the PDB of the individual PDU). This configuration implies multiple PDCP discardTimers per PDU Set, all with expiry time corresponding to the PSDB of the PDU Set. In a further example, there may be one PDCP discardTimer that is operated per PDCP SDU and in this configuration, different lengths of PDCP discard timers (taking into account the PSDB) are applied for SDUs of the same PDU Set to make them all expire at the same time, if the PDUs of the PDU Set do not all arrive at the WTRU at the same time. For example, a first batch of PDUs of a PDU Set (that arrived at a time t1) may have a larger discardTimer expiry time value compared to a second batch of PDUs of a PDU Set (that arrived at a time t2, where t2>t1). Still further, there may be one PDCP discardTimer that is operated per the PDU Set, which takes into account the PSDB of the PDU Set.

In embodiments, more than one configuration may be possible. For example, the gNB may configure whether the PDCP discardTimer is operated per PDCP SDU or per PDCP PDU Set. In another example, the WTRU may determine which option to use (PDCP discardTimer operated per PDCP SDU or per PDCP PDU Set) and/or how to configure the expiry timer value (based on PDB of individual PDU or based on PSDB of PDU Set or based on PSDB of PDU Set with increments/decrements according to arrival times at the WTRU) based on whether all PDCP SDUs belonging to a PDU Set arrive at the same time or in a staggered way.

As used herein, the PDCP discardTimer of XR data unit is used to describe a discard timer per PDCP SDU or per PDU Set according to any one or more of the options and examples described above.

In embodiments, the WTRU discard behavior may be based on discardTimer. The discard behavior at the WTRU (e.g., at PDCP layer in the WTRU) may be on a PDU basis or on a PDU Set basis. Further, one discardTimer per PDCP SDU for each SDU of a PDU Set. For example, each PDCP SDU is discarded at the expiry of its respective discardTimer (whether that discardTimer is based on the individual PDB of the PDU/PDCP SDU or the PDU Set delay budgets (PSDB) of the PDU Set it is part of). In addition, one discardTimer may be available per PDU Set. For example, at the expiry of the discardTimer or the time for retransmitting the first batch of PDUs, the transmitting PDCP entity (e.g., the WTRU for UL traffic) discards any PDU of that PDU Set that has not been successfully transmitted. In the event there is a discardTimer associated with each PDCP SDU as well as a discardTimer associated with the PDU Set, the WTRU may determine to prioritize the more stringent of the two conditions (e.g., prioritize the smaller of PDB or PSDB).

In embodiments, the WTRU discard behavior based on factors other than expiry of discard timer of data unit (e.g., discard timer of a dependent data unit, data type, etc.) In addition to the discardTimer value, the discard behavior at the WTRU (e.g., at PDCP layer in the WTRU) may be based on the data type or any indication from higher/application layer on the preferred handling of the XR data unit. This behavior may be configured at an entity (e.g., PDCP entity) at any AS layer in the WTRU (e.g., at the PDCP layer in the WTRU) or at an entity at a layer in the WTRU. An example of the layer may be an existing layer or a layer between the SDAP and PDCP layers in the WTRU which may be common to multiple PDCP entities in the WTRU. The WTRU discard behavior of a data unit (e.g., PDU Set 1) may be a function of any one or more of the following. Discard timer(s) of the data unit has expired or is within a small preconfigured time window of expiring. For example, the discard timer associated with PDU Set 1 has expired or is within a small preconfigured time window of expiring. Further, Discard timer(s) of one or more constituent part(s) of the data unit has expired or is within a small preconfigured time window of expiring. For example, the discard timer of one or more PDUs of PDU Set 1 has expired or is within a small preconfigured time window of expiring. In addition, Discard timer(s) of a dependent data unit has expired or is within a small preconfigured time window of expiring. For example, the discard timer of PDU Set 2 which is dependent on PDU Set 1 and/or which PDU Set 1 depends on has expired or is within a small preconfigured time window of expiring.

In embodiments, status reports may be provided to indicate one or more of the successful delivery of XR data unit, the successful delivery of a dependent XR data unit, the successful delivery of another XR data unit on which the XR data unit is dependent, unsuccessful delivery of XR data unit, unsuccessful delivery of a dependent XR data unit, and unsuccessful delivery of another XR data unit on which the XR data unit is dependent. For example, if the PDCP discard timer(s) for the XR data unit has expired or is within a small preconfigured time window of expiring and/or data type=PDU Set Type I (e.g., application cannot reconstruct the PDU Set with delay/loss of any PDU of PDU Set), the WTRU may discard the XR data unit or copies of the XR data unit. The XR data unit may be an entire PDU Set or some PDUs of a PDU Set. Further, if the PDCP discard timer(s) for the XR data unit has expired and/or data type of the XR data unit=PDU Set Type I and/or the WTRU (e.g., transmitting PDCP entity in the WTRU) may receive a status report from gNB (e.g., receiving PDCP entity in gNB) to indicate unsuccessful delivery of the XR data unit and/or there are dependencies between this XR data unit and another XR data unit (e.g., another PDU Set mapped to a different DRB/PDCP entity), the WTRU may send an indication to the one or more PDCP entities with the dependent data unit to drop all copies of the dependent data unit. In a further example, the WTRU may have determined dependencies between PDU Set 1 and PDU Set 2, such that without PDU Set 1, PDU Set 2 may be useless. For example, PDU Set 1 may be an I-frame and PDU Set 2 may be a differential P-/B-frame. If the PDCP discard timer(s) for PDU Set 1 has expired AND the WTRU (e.g., PDCP) has received a status report from gNB indicating unsuccessful delivery of one or more PDUs of PDU Set 1 AND the data type of PDU Set 1 is a PDU Set Type I which cannot tolerate any loss/delay of any PDU of the PDU Set for the successful reconstruction of the PDU Set, the WTRU (e.g., transmitting PDCP entity 1 carrying copies of PDU Set 1) may send an indication to PDCP entity 2 (carrying copies of PDU Set 2) to drop all copies of PDU Set 2 and/or any PDUs of PDU Set 2 since PDU Set 2 depends on the successful reconstruction of PDU Set 1.

In another example, if the dependent PDU Set has already been submitted to the lower layers (e.g., the WTRU RLC entity), the WTRU (e.g., PDCP entity) may send a discard indication to the lower layers (e.g., RLC entity) to avoid any gap in any sequence numbering. In this example, if the dependent PDU Set 2 has already been submitted from PDCP entity 2 to RLC entity 2, PDCP entity 2, on reception of an indication from PDCP entity 1 that the discard timer(s) of PDU Set 1 has expired AND one or more or all PDUs of PDU Set 1 was not successfully delivery to the gNB, may send an indication to RLC entity 2 to avoid any gap in sequence numbering. Following reception of this indication at RLC entity 2 from PDCP entity 2, RLC entity 2 may send an indication to the gNB or to the lower layers to indicate that PDU Set 2 is no longer useful. The indication may also contain the reason (e.g., due to unsuccessful delivery of part or all of PDU Set 1 or due to anticipated unsuccessful reconstruction of PDU Set 1 as a result of some or more or all PDUs of PDU Set 1 having incurred delay/loss).

In embodiments, there may be a layer/entity common to multiple PDCP entities in the WTRU. Example of the layer may be a layer between the SDAP and PDCP layers in the WTRU which may be common to multiple PDCP entities in the WTRU. For example, in a model where each type of PDU Set may be mapped to a different DRB (and therefore different PDCP entity) and there is a dependency between two or more such different PDU Sets (mapped to different PDCP entities), the common layer above the existing PDCP entity. For example, the common layer may (i) have visibility of all the dependent PDU Sets and the PDCP entities they are mapped to, (ii) send an indication to all PDCP entities with dependent PDU Sets to inform them about the dependencies, (ii) receive indication from the gNB, e.g., a status report to indicate successful, unsuccessful delivery of data unit and/or an indication to drop any data unit or dependent data unit, (iii) send an indication to all PDCP entities with dependent PDU Sets informing them of successful/unsuccessful delivery indication from the gNB, (iv) may handle one or more discard timer and/or have visibility of the discard timer(s) at the one more PDCP entities, (v) determine dependencies between data units (e.g., between PDU Set 1 and PDU Set 2), and (vi) send a discard indication to a PDCP entity to drop a dependent data unit (e.g., to PDCP entity 2 to drop PDU Set 2 following status report from gNB indicating unsuccessful delivery of PDU Set 1).

In any of the embodiments and examples described above, following discard of a dependent PDU Set, the WTRU may send an indication to the gNB (e.g., corresponding PDCP entity in gNB) to inform the gNB of the discard. The indication may include ways to identity the PDU Set that was discarded and/or any context associated with the PDU Set that was discarded (e.g., Serial number, Sequence number, etc.). In one example, the WTRU may determine that PDU Set 1 and PDU Set 2 are dependent. The WTRU may discard PDU Set 2 if the discard timer(s) for PDU Set 1 has expired and PDU Set 1 was not successfully transmitted to the gNB (e.g., the WTRU may have received a status report from the gNB indicating unsuccessful delivery of PDU Set 1 or a request from the gNB to resend PDU Set 1).

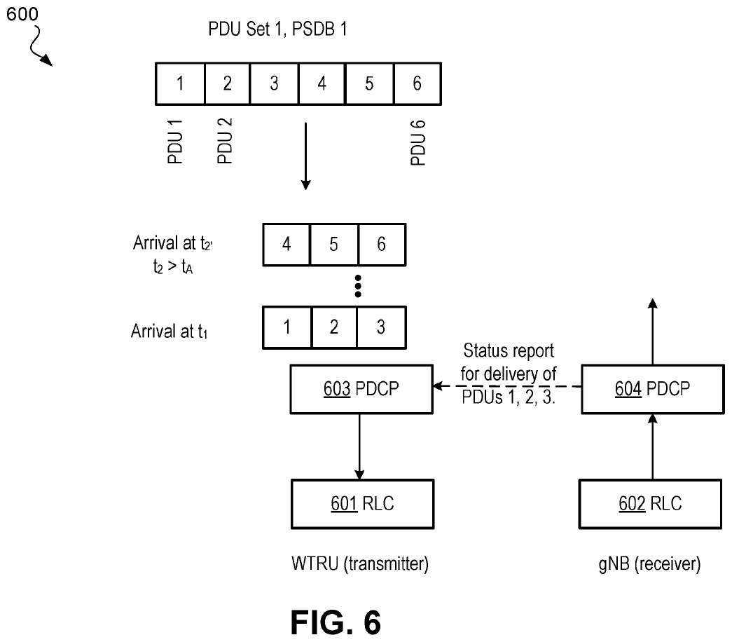

In embodiments, discard mechanism enhancements may be applied when PDUs in PDU Set arrive sequentially. FIG. 6 illustrates a process 600 that shows an example of a discard mechanism for the sequential arrival of PDUs of the PDU Set at the PDCP entity. PDUs of a PDU set transmitted from RLC 601 may be based on one or more PDUs of a PDU set received and one or more PDUs of the PDU set not received. Each of the 6 PDUs of PDU Set 1 may be received at the PDCP 603 and transmitted via the RLC 601 of the WTRU. The PDU Set 1 may be received at the receiver (e.g., gNB) within PSDB 604, via the RLC 602, to maintain dependency within the PDU set. The transmitting PDCP 603 may send each of the PDUs in the PDU Set 1 within tA and tA<PSDB1. Transmitting PDCP 603 may send each of the PDUs within tA′ and tA′≤tA. tA may include a time by which transmitting PDCP entity 603 may have to send PDUs of PDU Set 1 to meet PSDB1. When PDUs 1, 2, 3 are received at t1, t1, <tA′ and PDUs 4,5,6 are not yet received, the WTRU may take different actions. If the WTRU receives a resend indication for PDUs 1, 2, 3 from receiving entity (gNB), the WTRU may determine not to resend PDUs 1, 2, 3 if PDUs 4, 5, 6 are not yet received at WTRU, even if PDCP timer at WTRU is still running. PDCP 603 at WTRU may drop copies of PDUs 1, 2, 3 at the approach of tA, if PDUs 4, 5, 6 have not yet been received at the WTRU; even if WTRU has not received a status report (from gNB) confirming successful delivery of PDUs 1, 2, 3 at receiving end. to may include the time by which transmitting PDCP entity 603 has to send PDUs of PDU Set 1 (e.g., to lower layers in the WTRU) to meet PSDB1. t_{A′} may include the time by which transmitting PDCP entity 603 may have to receive PDUs of PDU Set 1 (e.g., from application layer in the WTRU) to meet PSDB1, such that t_{′}≤t_{A}. Further, the first batch of PDUs: e.g., PDUs 1, 2, 3 of PDU Set 1 received at time t₁, t₁<t_{A′}. The remaining PDUs: e.g., PDUs 4, 5, 6 of PDU Set 1 received at time t₂, t₂<t₁.

As an example, the WTRU may receive a first batch of PDUs of a PDU Set from XR application at time t₁, t₁<t_{A′}. The WTRU transmits the first batch of PDUs of PDU Set in the UL to a network entity. The WTRU may receive a resend indication from the network entity for first batch of PDUs from gNB (e.g., receiving PDCP entity 604 at gNB). If the WTRU has received remaining PDUs of PDU Set by t_{A′} and the PDCP timer(s) for first batch of PDUs of PDU Set is still running, the WTRU transmits remaining PDUs of PDU Set in the UL, and the WTRU retransmits the first batch of PDUs following resend indication from gNB. If the WTRU has not received remaining PDUs of PDU Set by ta', the WTRU determines not to resend first batch of PDUs of the PDU Set, even if PDCP timer(s) for first batch still running. The WTRU may determine to drop first batch of PDUs of PDU Set, and the WTRU may send an indication to gNB (receiving PDCP entity 604 at gNB) that the first batch of PDUs of the PDU Set will not be retransmitted (to avoid any gap in sequence numbering). Further, if the WTRU has not the remaining PDUs, the WTRU may include a reason why retransmission is not being followed through despite resend indication from gNB (failure to receive remaining PDUs of PDU Set on time).

In embodiments, there may be timing considerations for sequential arrival of PDUs of a PDU Set. For example, each of the PDUs of a PDU Set may not arrive at the same time (e.g., due to UL jitter from the codec generating the traffic in the WTRU). The PDUs of a PDU Set may arrive (at the lower layers in the WTRU) in two or more batches of PDUs from the application layer in the WTRU. Each batch or batch of PDUs may contain one or more PDUs of a PDU Set. The lower layers in the WTRU (e.g., AS layers) may need to keep track of the arrival times to ensure that the following treatment of the data units still respect the corresponding delay budget (e.g., PSDB for PDU Set, PDB for PDU). Each of the PDUs of a PDU Set may need to be received at the receiver (at the gNB for UL traffic) within the PSDB to maintain the dependency within the PDU Set and/or maintain the integrity of the PDU Set. The transmitting entity in the WTRU (e.g., transmitting PDCP entity) may need to ensure to send each of the PDUs in the PDU Set within a time constraint t_{A}, where t_{A}<PSDB of the PDU Set. Further, to be able to send each of the PDUs in the PDU Set within a time constraint t_{A}, the transmitting entity in the WTRU (e.g., transmitting PDCP entity) may need to receive each of the PDUs of the PDU Set within a time constraint t_{A}′, where t_{A}′≤t_{A}. If the PDUs of a PDU Set arrive sequentially at the WTRU (e.g., from the XR application), the WTRU may assign different time constraints by which each batch may need to be received. For example, if PDU batches 1, 2 and 3 of the same PDU Set arrive at times t₁, t₂ and t₃ respectively where t₁<t₂<t₃, the WTRU (e.g., transmitting PDCP entity) may assign time constraints by which each batch may need to transmitted to the lower layers to ensure that each of the PDUs can be transmitted in a timely manner, for example, PDU batches 1, 2 and 3 may need to be transmitted within time intervals tₓ, t_{y}, and t_{z} respectively where t_{z}<t_{y}<tₓ.

In embodiments, the WTRU may determine not to resend a batch of PDUs of PDU Set despite resend request from gNB instructing the WTRU to do so. As an example, despite receiving a request/indication from the gNB to resend some data units (e.g., remaining PDUs of a PDU Set), the WTRU may determine not to resend them if the WTRU knows that other data units (e.g., other PDUs of the PDU Set) cannot be transmitted within the time constraints (e.g., PSDB of PDU Set). The WTRU may determine to drop the data units (partial PDUs of PDU Set) if it deems that the remaining PDUs of the PDU Set may not arrive at the WTRU (e.g., lower/AS layers in the WTRU) within t_{A}′). In one example, the WTRU (e.g., PDCP entity at WTRU) may receive some partial data unit (e.g., PDUs 1, 2, 3 of PDU Set 1) at time t₁ where t₁<t_{A}′, time limit by which the transmitting PDCP needs to receive PDUs of a PDU Set to ensure that the PSDB is met. The WTRU knows about the size of the whole data unit (e.g., that PDU Set 1 has 6PDUs in total) and about the type of the data unit (e.g., PDU Set 1 is a Type I PDU Set whereby the application cannot tolerate any loss/delay for any PDU of the PDU Set). In another example, the WTRU may transmit the partial data units it has received (e.g., PDUs 1, 2, 3 of PDU Set 1) to the gNB, without waiting for the remaining PDUs of the PDU Set (e.g., PDUs 4, 5, 6 of PDU Set 1). In a further example, if the WTRU may receive a resend indication from the gNB to resend the data units it has transmitted (e.g., PDUs 1, 2, 3 of PDU Set 1) while the discard timer(s) for these data units (e.g., PDUs 1, 2, 3 of PDU Set 1) may still be running, the WTRU may decide to not resend them (and/or to drop) PDUs 1, 2, 3 of PDU Set 1 if the remaining data units of the PDU Set (e.g., PDUs 4, 5, 6 of PDU Set 1) have not yet been received at the WTRU (e.g., from the XR application) and t_{A}′ has passed or is fast approaching. The WTRU may determine that the chances of it receiving the remaining PDUs of PDU Set 1 within t_{A}′ and the WTRU being able to transmit the PDUs to the lower layers within t_{A} are too low. Since is it unlikely that PDUs 4, 5, 6 will be transmitted to the gNB and received within a timely manner, and PDU Set 1 is a Type I PDU Set which cannot tolerate any loss/delay of any PDU, the WTRU may determine to not resend PDUs 1,2,3 of PDU Set 1 despite a request from the gNB to do so and/or even though the discard timer corresponding to PDUs 1,2,3 may not have expired yet.

In another example of the WTRU determining not to resend a batch of PDUs of PDU Set, where the WTRU has determined not to resend a batch of data units to the gNB despite having received a request from the gNB to do so while the PDCP timer(s) for that batch of data units may still be running (as described above), the WTRU may send an indication to the gNB (e.g., receiving PDCP entity at gNB) to avoid any gap in any sequence numbering at the gNB and any unnecessary delay in solving such gap. Indication sent by the WTRU to the gNB may include one or both of an indication that a batch of PDUs of a PDU Set will not be retransmitted (e.g., first batch of PDUs in PDU Set 1, PDUs 1,2,3) will not be retransmitted, and the reason why retransmission is not being followed though despite resend request from gNB to do so, for e.g., failure to receive remaining PDUs of PDU Set in timely manner means that PDU Set cannot be reconstructed. For example, since PDUs 4,5,6 of PDU Set 1 were not received at WTRU (e.g., from application layer) within t_{A}′.

In another example, upon reception of a first batch of data units as part of a larger data unit (e.g., on reception of PDUs 1,2,3 of PDU Set 1), with the knowledge of the size of the larger data unit (e.g., that PDU Set 1 has a total of 6 PDUs) and the type of the larger data unit (e.g., that PDU Set 1 is a Type I PDU Set that cannot tolerate any loss/delay of any PDU of the PDU Set), the WTRU (e.g., transmitting PDCP entity in the WTRU) may decide/determine to wait until it has received each of the data units of the larger data unit (e.g., PDUs 1,2,3,4,5,6 of PDU Set 1) before transmitting them to the lower layers and thus to the gNB. In such a case, if the WTRU has not received any one of the data units as part of the larger data unit (any one of PDUs 1-6) within t_{A}′, the time by which transmitting PDCP entity has to receive PDUs of PDU Set 1 (e.g., from application layer in the WTRU) to meet the PSDB of PDU Set 1, the WTRU may determine to not send any of the data units it may have received. For example, if the WTRU has received PDUs 1,2,3,4,5 of PDU Set 1 within t_{A}′, the WTRU may not transmit PDUs 1,2,3,4,5 of PDU Set 1 until PDU 6 of PDU Set 1 is received. If PDU 6 of PDU Set 1 is not received within t_{A}′, the WTRU drops each of the PDUs of PDU Set 1. It is assumed that the WTRU knows that PDU Set 1 is a Type I PDU Set.

In embodiments, there may be one PDCP discard timer or multiple PDCP discard timers per PDU Set. With XR traffic consisting of one or more PDUs in a PDU Set and one or more PDU Set in a data burst with dependencies between constituent PDUs in a PDU Set or constituent PDU Sets in a data burst, the following one or more aspects may be considered when configuring the PDCP discard timer. For example, there may be one PDCP discardTimer that is operated per PDCP SDU, where the expiry of the timer takes into account the Packet Delay Budget (PDB) of the individual PDU. Thus, whether the time for retransmitting the first batch of PDUs has not expired may be based on a Packet Delay Budget (PDB) of each of the PDUs. This configuration implies multiple PDCP discardTimers per PDU Set. In another example, there may be one PDCP discardTimer that is operated per PDCP SDU and in this configuration, the expiry of each constituent timer of each PDU Set takes into account the PSDB of the PDU Set (and not the PDB of the individual PDU). Thus, whether the time for retransmitting the first batch of PDUs has not expired may be based on a PDU-set Delay Budget (PSDB) of the PDU set. This configuration implies multiple PDCP discardTimers per PDU Set, each with expiry time corresponding to the PSDB of the PDU Set. In a further example, there may be one PDCP discardTimer that is operated per PDCP SDU and in this configuration, different lengths of PDCP discard timers (taking into account the PSDB) are applied for SDUs of the same PDU Set to make them each expire at the same time, if the PDUs of the PDU Set do not each arrive at the WTRU at the same time. For example, a first batch of PDUs of a PDU Set (that arrived at a time t1) may have a larger discardTimer expiry time value compared to a second batch of PDUs of a PDU Set (that arrived at a time t2, where t2>t1). Still further, there may be one PDCP discardTimer that is operated per the PDU Set, which takes into account the PSDB of the PDU Set.

In a further example of one PDCP discard timer or multiple PDCP discard timers per PDU Set, more than one configuration may be possible. For example, the gNB may configure whether the PDCP discardTimer is operated per PDCP SDU or per PDCP PDU Set. Further, the WTRU may determine which option to use (PDCP discardTimer operated per PDCP SDU or per PDCP PDU Set) and/or how to configure the expiry timer value (based on PDB of individual PDU or based on PSDB of PDU Set or based on PSDB of PDU Set with increments/decrements according to arrival times at the WTRU) based on whether each PDCP SDUs belonging to a PDU Set arrive at the same time or in a staggered way.

As discussed herein, the term PDCP discardTimer of XR data unit is used to describe a discard timer per PDCP SDU or per PDU Set, as is discussed in the options immediately above.

In an embodiment of discard method enhancements, the WTRU discard behavior may be based on discardTimer. For example, the discard behavior at the WTRU (e.g., at PDCP layer in the WTRU) may be on a per-PDU basis or on a per-PDU Set basis. As such, there may be one discardTimer or the time for retransmitting the first batch of PDUs per PDCP SDU for each SDU of a PDU Set. For example, each PDCP SDU is discarded at the expiry of its respective discardTimer (whether that discardTimer is based on the individual PDB of the PDU/PDCP SDU or the PSDB of the PDU Set it is part of). In addition, there may be one discardTimer per PDU Set. For example, at the expiry of the discardTimer of the PDU Set, the transmitting PDCP entity (e.g., the WTRU for UL traffic) discards any PDU of that PDU Set that has not been successfully transmitted. In the event there is a discardTimer or the time duration for retransmitting the XR data associated with each PDCP SDU as well as a discardTimer associated with the PDU Set that the PDCP SDU/PDU is part of, the WTRU may determine to prioritize the more stringent of the two conditions (e.g., prioritize the smaller of PDB or PSDB).

In embodiments, the WTRU discard behavior may be based on factors other than expiry of discard timer of data unit (e.g., dependencies, data type, number/percentage of PDUs within a PDU Set that has already been received at the lower layer in the WTRU/multiplexed into TBs/transmitted in the UL, remaining number of PDUs of a PDU Set that have not yet been received at the lower layers in the WTRU, discard timer of a dependent data unit, etc.). A discard behavior of the PDU set may be based on dependencies, data types, a number of PDUs of the PDU set received, or a number of the second batch of PDUs of the PDU set received. For example, in addition to the discardTimer value of the one or more PDCP discard timer(s), the discard behavior at the WTRU (e.g., at PDCP layer in the WTRU) may be based on other factors, for example, the discard timer value of another dependent data unit, the data type of the data unit or any indication from higher/application layer on the preferred handling of the XR data unit. This behavior may be configured at an entity (e.g., PDCP entity) at any AS layer in the WTRU (e.g., at the PDCP layer in the WTRU) or at an entity at a layer in the WTRU. Example of the layer may be a layer between the SDAP and PDCP layers in the WTRU which may be common to multiple PDCP entities in the WTRU. Further, the WTRU discard behaviour of a data unit (e.g., PDU Set 1) may be a function of one or more elements. For example, the discard timer(s) of the data unit may have expired or is within a small preconfigured time window of expiring. For example, the discard timer associated with PDU Set 1 has expired. For example, the discardTimer associated with PDU set 1 may be within less than 5 ms of expiry. In another example, the discardTimer associated with PDU set 1 may be within a short time of expiry. For example, a short time of expiry may mean a time duration corresponding to 10% of the discardTimer value, and/or a time duration corresponding to 15% of the PSDB value, etc. In another example, the discard timer(s) of one or more constituent part(s) of the data unit has expired or is within a small preconfigured time window of expiring, e.g., the discard timer of one or more PDUs of PDU Set 1 has expired or PDU Set 1 has 6 PDUs in total. The lower layers in the WTRU have received PDUs 1,2,3, and have not yet received PDUs 4,5,6. If the discard timer for any one or more of PDUs 4,5,6 expire while the WTRU has not yet received PDUs 4,5,6, the WTRU may discard PDUs 1,2,3 as well. In a further example, PDU Set 1 has 6 PDUs in total. The lower layers in the WTRU have received PDUs 1,2,3, and have not yet received PDUs 4,5,6. If the discard timer corresponding to the PSDB of the PDU Set expires while the WTRU has not yet received PDUs 4,5,6, the WTRU may discard PDUs 1,2,3 as well.

In embodiments, the discard timer(s) of a dependent data unit may expire or may be within a small preconfigured time window of expiring. For example, the discard timer of PDU Set 2 which is dependent on PDU Set 1 and/or which PDU Set 1 depends on has expired. Additional options include, a status report to indicate successful delivery of XR data unit; a status report to indicate successful delivery of a dependent XR data unit, a status report to indicate successful delivery of another XR data unit on which the XR data unit is dependent, a status report to indicate unsuccessful delivery of XR data unit, a status report to indicate unsuccessful delivery of a dependent XR data unit, a status report to indicate unsuccessful delivery of another XR data unit on which the XR data unit is dependent, or any combination of one or more of the above;

As an example of the above, if the PDCP discard timer(s) for the XR data unit has expired or is within a small preconfigured time window of expiring and/or data type=PDU Set Type I (e.g., application cannot reconstruct the PDU Set with delay/loss of any PDU of PDU Set), the WTRU may discard the XR data unit or copies of the XR data unit. The XR data unit may be an entire PDU Set or some PDUs of a PDU Set. In another example, if the PDCP discard timer(s) for the XR data unit has expired or is within a small preconfigured time window of expiring and/or data type of the XR data unit=PDU Set Type I and/or the WTRU (e.g., transmitting PDCP entity in the WTRU) has received a status report from gNB (e.g., receiving PDCP entity in gNB) to indicate unsuccessful delivery of the XR data unit and/or there are dependencies between this XR data unit and another XR data unit (e.g., another PDU Set mapped to a different DRB/PDCP entity), the WTRU may send an indication to the one or more PDCP entities with the dependent data unit to drop each of the copies of the dependent data unit. Whether the time duration for retransmitting the XR data has expired may be based on a dependent data unit or a data type As such, the WTRU may have determined dependencies between PDU Set 1 and PDU Set 2, such that without PDU Set 1, PDU Set 2 may be useless. For example, PDU Set 1 may be an I-frame and PDU Set 2 may be a differential P-/B-frame. If the PDCP discard timer(s) for PDU Set 1 has expired AND the WTRU (e.g., PDCP) has received a status report from gNB indicating unsuccessful delivery of one or more PDUs of PDU Set 1 AND the data type of PDU Set 1 is a PDU Set Type I which cannot tolerate any loss/delay of any PDU of the PDU Set for the successful reconstruction of the PDU Set, the WTRU (e.g., transmitting PDCP entity 1 carrying copies of PDU Set 1) may send an indication to PDCP entity 2 (carrying copies of PDU Set 2) to drop each of the copies of PDU Set 2 and/or any PDUs of PDU Set 2 since PDU Set 2 depends on the successful reconstruction of PDU Set 1.

In embodiments, if the dependent PDUs/PDU Set has already been submitted to the lower layers (e.g., the WTRU RLC entity), the WTRU (e.g., PDCP entity) may send a discard indication to the lower layers (e.g., RLC entity) to avoid any gap in any sequence numbering. As such, if the dependent PDU Set 2 has already been submitted from PDCP entity 2 to RLC entity 2, PDCP entity 2, on reception of an indication from PDCP entity 1 that the discard timer(s) of PDU Set 1 has expired AND one or more or all PDUs of PDU Set 1 was not successfully delivery to the gNB, may send an indication to RLC entity 2 to avoid any gap in sequence numbering. Further, following reception of this indication at RLC entity 2 from PDCP entity 2, RLC entity 2 may send an indication to the gNB or to the lower layers to indicate that PDU Set 2 is no longer useful. The indication may also contain the reason (e.g., due to unsuccessful delivery of part or all of PDU Set 1 or due to anticipated unsuccessful reconstruction of PDU Set 1 as a result of some or more or all PDUs of PDU Set 1 having incurred delay/loss). As an example, if PDUs 1,2,3 of PDU Set 1 have already been submitted to the lower layers (e.g., RLC entity) while PDUs 4,5,6 of PDU Set 1 have not yet arrived at the WTRU while the discard timer for PDUs 4,5,6 and/or the discard timer for PDU Set 1 has expired or is within a small preconfigured time window of expiring, the WTRU may send an indication to the lower layers (RLC entity) to inform it to drop PDUs 1,2,3 of PDU Set 1 (to avoid any gap in sequence numbering).

An exemplary embodiment of a discard mechanism enhancement may be applied when the PDUs in a PDU Set arrive at the same time. The steps may include the WTRU receiving the XR data from XR application, e.g., PDU Set 1. The WTRU detects the flag for PSII or identify data type. The WTRU transmits XR data in the UL to gNB. The WTRU receives a status report from the gNB indicating NACK, such as, retransmit some or all PDUs of the PDU Set (e.g., PDU Set 1). If the PDCP timer is still running (e.g., PDU timers or PDU set timer(s) for the PDU set (such as PDU Set 1), the WTRU retransmits the PDUs of the PDU set. If the PDCP timer(s), e.g., PDU timer(s) or PDU Set timer(s) for XR data unit has expired, the and the data type=PDU Set Type II, the WTRU may fall back to discarding any remaining PDUs of PDU Set 1. For example, if the PDCP timer(s) for the XR data unit has expired and the data type=PDU Set Type I, (i) the WTRU may discard XR data units (e.g., copies of PDU Set 1 or remaining PDUs of PDU Set 1), (ii) the WTRU may indicate to dependent PDCP entities to drop each of the dependent XR data units (e.g., PDU Set 2), and (iii) if the dependent PDU Set in dependent PDCP entity (e.g., PDCP 2) has already been submitted to the lower layers (e.g., the WTRU RLC entity), the WTRU (e.g., PDCP 2) may send a discard indication to lower layers (e.g., RLC 2) to avoid SN gap.

In a further exemplary embodiment for the discard mechanism, when the PDUs/PDU Sets are successfully delivered, the steps may include the WTRU receiving XR data from XR application, e.g., PDU Set 1, the WTRU transmits XR data in the UL to gNB, and if the WTRU receives a status report indicating successful delivery of XR data at the gNB, the WTRU (transmitter side) discards copies of the successfully delivered PDU Set following reception of a status report from the gNB (receiver side). Status reports may be sent from the receiver (e.g., receiving PDCP entity in network) to the transmitter (e.g., transmitting PDCP entity in WTRU) to confirm successful delivery of a PDU. Such status report may be on a per-PDU basis. There may be one status report transmitted from the receiver to the transmitter to indicate the delivery status of the PDU set (e.g., one status report per PDU set). The delivery status may include successful or unsuccessful delivery or delayed delivery of the PDU set.

Another exemplary embodiment of a discard mechanism enhancement may be applied when PDUs in PDU Set arrive sequentially. The process may include the WTRU receiving a first batch of PDUs of a PDU Set from XR application at time t₁, t₁<t_{A′}. The WTRU transmits a first batch of PDUs of PDU Set in the UL. The WTRU receives a resend indication for first batch of PDUs from gNB (e.g., receiving PDCP entity at gNB). If the WTRU has received the PDUs of PDU Set by ta′ and the PDCP timer(s) for first batch of PDUs of PDU Set is still running, (i) the WTRU transmit the remaining PDUs of PDU Set in the UL, and (ii) the WTRU may retransmit the first batch of PDUs following resend indication from gNB. If the WTRU has not received remaining PDUs of PDU Set by ta: (i) the WTRU determines not to resend first batch of PDUs of the PDU Set, even if PDCP timer(s) for first batch still running, and (ii) the WTRU sends an indication to gNB (receiving PDCP entity at gNB) that the first batch of PDUs of the PDU Set will not be retransmitted (to avoid any gap in sequence numbering). Further, the WTRU may include an indication as to why retransmission is not being followed through despite resend indication from gNB (failure to receive remaining PDUs of PDU Set on time).

In another exemplary embodiment of a discard mechanism enhancement may be applied when PDUs in PDU Set arrive sequentially, the steps of the WTRU receiving PDUs 1, 2, 3 of PDU Set 1 from the XR application at time t₁, t₁<t_{A′}. The WTRU may then transmit PDUs 1, 2, 3 of PDU Set 1 in the UL. The WTRU may then receive a resend indication for PDUs 1, 2, 3 of PDU Set 1 from the gNB. If the WTRU has received PDUs 4, 5, 6 by time t_{A′}, the WTRU may transmit PDUs 4, 5, 6 of PDU Set 1 in the UL and retransmits PDUs 1, 2, 3 of PDU Set 1. If the WTRU has not received PDUs 4, 5, 6 by time t_{A′}, the WTRU may determine to no resend PDUs 1, 2, 3 of PDU Set 1 and send an indication to the gNB that the PDUs 1, 2, 3 of PDU Set 1 will not be retransmitted. Again, the WTRU may include an indication as to why retransmission is not being followed through.

The terms and concepts disclosed herein may include terms and concepts not disclosed or described in those standard documents, and thus the concepts and terms herein are not meant to be solely limited to how such terms are used in the existing standards. Rather, these standards are referenced to the extent necessary in order to provide background reference for understanding.

The processes and instrumentalities described herein may apply in any combination, may apply to other wireless technologies, and for other services. A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. A wireless transmit/receive unit (WTRU) comprising a processor configured to:
receive, from an extended reality (XR) application, a first batch of protocol data units (PDUs) of a PDU set;
transmit the first batch of PDUs of the PDU set to a network entity;
receive a resend indication from the network entity for the first batch of PDUs of the PDU set;
in response to a determination that time for retransmitting the first batch of PDUs has not expired and a second batch of PDUs of the PDU set have been received, retransmit at least a portion of the first batch of PDUs and transmit the second batch of PDUs of the PDU set; and
in response to a determination that the time for retransmitting the first batch of PDUs has not expired and the second batch of PDUs of the PDU set have not been received, indicate to the network entity that the first batch of PDUs will not be retransmitted.

2. The WTRU of claim 1, wherein the processor is further configured to:
in response to the determination that the time for retransmitting the first batch of PDUs has not expired and the second batch of PDUs of the PDU set have not been received, indicate to the network entity a reason that the first batch of PDUs will not be retransmitted.

3. The WTRU of claim 1, wherein whether the time for retransmitting the first batch of PDUs has not expired is based on a Packet Delay Budget (PDB) of each of the PDUs, or based on a PDU-set Delay Budget (PSDB) of the PDU set.

4. The WTRU of claim 3, wherein the processor is further configured to:
in response to a determination that whether the time for retransmitting the first batch of PDUs has not expired is based on a Packet Delay Budget (PDB) of each of the PDUs, discard each PDUs at an expiry of its respective discard timer.

5. The WTRU of claim 3, wherein the processor is further configured to:
in response to a determination that whether the time for retransmitting the first batch of PDUs has not expired is based on a PDU-set Delay Budget (PSDB) of the PDU set, discard PDUs of the PDU set that were not successfully transmitted when the time for retransmitting the first batch of PDUs has expired.

6. The WTRU of claim 1, wherein the processor is further configured to:
in response to a determination that the time for retransmitting the at least the portion of the first batch of PDUs has not expired is associated with both of Packet Data Convergence Protocol (PDCP) entities and the PDU set, prioritize a smaller of a Packet Delay Budget (PDB) or a PDU-set Delay Budget (PSDB).

7. The WTRU of claim 1, wherein a discard behavior of the PDU set is a function of a status report to indicate successful or unsuccessful delivery of the PDU set, or a status report to indicate successful or unsuccessful delivery of a dependent PDU set.

8. The WTRU of claim 1, wherein a discard behavior of the PDU set is based on dependencies, data types, a number of PDUs of the PDU set received, or a number of the second batch of PDUs of the PDU set received.

9. A method implemented by a wireless transmit/receive unit (WTRU), the method comprising:
receiving, from an extended reality (XR) application, a first batch of protocol data units (PDUs) of a PDU set;
transmitting the first batch of PDUs of the PDU set to a network entity;
receive a resend indication from the network entity for the first batch of PDUs of the PDU set;
in response to a determination that time for retransmitting the first batch of PDUs has not expired and a second batch of PDUs of the PDU set have been received, retransmitting at least a portion of the first batch of PDUs and transmitting the second batch of PDUs of the PDU set; and
in response to a determination that the time for retransmitting the first batch of PDUs has not expired and the second batch of PDUs of the PDU set have not been received, indicating to the network entity that the first batch of PDUs will not be retransmitted.

10. The method of claim 9, further comprising:
in response to the determination that the time for retransmitting the first batch of PDUs has not expired and the second batch of PDUs of the PDU set have not been received, indicating to the network entity a reason that the first batch of PDUs will not be retransmitted.

11. The method of claim 9, wherein whether the time for retransmitting the first batch of PDUs has not expired is based on a Packet Delay Budget (PDB) of each of the PDUs, or based on a PDU-set Delay Budget (PSDB) of the PDU set.

12. The method of claim 11, further comprising:
in response to a determination that whether the time for retransmitting the first batch of PDUs has not expired is based on a Packet Delay Budget (PDB) of each of the PDUs, discarding each PDUs at an expiry of its respective discard timer.

13. The method of claim 11, further comprising:
in response to a determination that whether the time for retransmitting the first batch of PDUs has not expired is based on a PDU-set Delay Budget (PSDB) of the PDU set, discarding PDUs of the PDU set that were not successfully transmitted when the time for retransmitting the first batch of PDUs has expired.

14. The method of claim 9, further comprising:
in response to a determination that the time for retransmitting the at least the portion of the first batch of PDUs has not expired is associated with both of Packet Data Convergence Protocol (PDCP) entities and the PDU set, prioritizing a smaller of a Packet Delay Budget (PDB) or a PDU-set Delay Budget (PSDB).

15. The method of claim 9, wherein a discard behavior of the PDU set is a function of a status report to indicate successful or unsuccessful delivery of the PDU set, or a status report to indicate successful or unsuccessful delivery of a dependent PDU set.

16. The method of claim 9, wherein a discard behavior of the PDU set is based on dependencies, data types, a number of PDUs of the PDU set received, or a number of the second batch of PDUs of the PDU set received.
